(19) United States
(12) Patent Application Publication
(10) Pub. No.: US 2025/0292371 A1
(43) Pub. Date: Sep. 18, 2025

(54) AI-BASED CHARACTERISTIC GUIDANCE METHOD AND SYSTEM FOR ENHANCING QUALITY OF DIFFUSION MODELS

(71) Applicant: The Hong Kong University of Science and Technology, Hong Kong (CN)

(72) Inventors: Candi ZHENG, Hong Kong (CN); Yang WANG, Hong Kong (CN); Yuan LAN, Hong Kong (CN)

(21) Appl. No.: 19/064,720

(22) Filed: Feb. 27, 2025

Related U.S. Application Data
(60) Provisional application No. 63/565,537, filed on Mar. 15, 2024.

(51) Int. Cl. G06T 5/60; G06T 5/70

(52) U.S. Cl. CPC G06T 5/60; G06T 5/70; G06T 2207/20081; G06T 2207/20084

(57) ABSTRACT

The invention provides artificial intelligence-based characteristic guidance method and system for enhancing quality of a diffusion model in generating a data from a noisy data based on a condition information. The method comprises: generating a nonlinear precorrection vector; performing, by a regularization module, a context regularization iteration to obtain an updated nonlinear correction vector and a nonlinear correction gradient; checking if a convergence criterion is met; and denoising the noisy data based on the updated nonlinear correction vector to generate the data. By using the regularization module, the provided characteristic guidance method not only greatly improves the stability of data generation by the diffusion model, but also provides enhanced control over context through two context modes: the detail enhancement mode and the context enhancement mode. The present invention can enhance the semantic characteristics of prompts and mitigate irregularities in image generation.

### CROSS-REFERENCE TO RELATED APPLICATIONS

The present application claims priority from the U.S. Provisional Patent Application No. 63/565,537 filed Mar. 15, 2024, and the disclosure of which is incorporated herein by reference in its entirety.

### FIELD OF THE INVENTION

The present invention generally relates to guided generative diffusion technologies. More specifically the present invention relates to characteristic guidance method and system for enhancing quality of diffusion model.

### BACKGROUND OF THE INVENTION

Diffusion models, such as denoising diffusion probabilistic model (DDPM), models distributions of data ρ(x) by recovering an original data x₀˜p(x) from one of its noise contaminated versions xᵢ. The noise contaminated data is a linear combination of the original image and a gaussian noise:

$${x}_{i} = \sqrt{{\overline{α}}_{i}} {x}_{0} + \sqrt{1 - {\overline{α}}_{i}} {\overline{ϵ}}_{i} ; 1 \leq i \leq n , \qquad ( 1 )$$

where n is the total diffusion steps, α̅ⁱ is the contamination weight at a time tᵢ∈[0, T] in the forward diffusion process, and ∈̅ᵢ is a standard Gaussian random noise.

The DDPM trains a denoising neural network ϵ(x, tᵢ) to predict and remove the noise from the noisy data under an objective of minimizing a denoising loss function:

$$L ( {ϵ}_{θ} ) = \frac{1}{n} {\sum }_{i = 1}^{n} {E}_{{x}_{0} ∼ p ( x ) {\overline{ϵ}}_{i} ∼ 𝒩 ( 0 , I )} {‖ {\overline{ϵ}}_{i} - {ϵ}_{θ} ( {x}_{i} , {t}_{i} ) ‖}_{2}^{2} \qquad ( 2 )$$

In the ideal scenario where diffusion time steps among tᵢ are infinitesimal, the optimal solution for the denoising objective (2) is defined

$$ϵ ( x , t ) {=}^{arg} {}_{{ϵ}_{θ}}^{min} L ( {ϵ}_{θ} ) \qquad ( 3 )$$

The forward diffusion process represented by Eq. (1) places stringent constraints on permissible forms of the denoising neural networks. First, ϵ(x, tᵢ) is proportional to the score function s(x, tᵢ)=∇ₓ_{ᵢ} log ρ(xᵢ). Second, the score function is a solution of the score FP equation, which could be rewritten in terms of

$$\frac{\partial ϵ}{\partial f} = \frac{1}{2} ( ℒϵ - \frac{1}{σ ( t )} {∇}_{x} {‖ ϵ ‖}_{2}^{2} ) , \qquad ( 4 )$$

in which

$$ℒϵ = {∇}_{x} ( ϵ \cdot x ) + {∇}_{x}^{2} ϵ + \frac{1 - {σ ( t )}^{2}}{{σ ( t )}^{2}} ϵ$$

and σ(t)=\sqrt{1−e^{-t}}. These constraints lay the foundation for duality between forward and backward diffusion processes, which is essential for successful sampling from the distribution ρ(x).

Conditional DDPMs, which generate data based on a given condition c, model the conditional distribution p(x|c) with a denoising neural network represented as ϵ_{θ}(x|c, tᵢ). However, the training data in practice might only have weak or noised in-formation about condition c, therefore we need a way to enhance the control strength in this situation.

Guidance is a technique for conditional data generation that trades off control strength and image diversity. It generally aims to sample from the distribution:

$$p ( x \vert c , ω ) ∝ {p ( x \vert c )}^{1 + ω} {p ( x )}^{- ω} ∝ {p ( c \vert x )}^{1 + ω} p ( x ) , \qquad ( 5 )$$

where ω>0 is the guidance scale. When ω is large, this distribution concentrates on samples that have the highest conditional likelihood p(clx).

Classifier guidance, requiring an additional classifier, faces implementation challenges in non-classification tasks like text-to-image generation. Classifier-free guidance circumvents this by linearly combining conditional and unconditional DDPM weighted by the guidance scale parameter ω. More specifically, classifier free guidance use the following guided denoising neural network ϵ_{CF}, deduced by using ϵ∝∇ log p, to approximately sample from p(x|c, ω):

$${ε}_{CF} ( x \vert c , {t}_{i} , ω ) = ( 1 + ω ) {ϵ}_{θ} ( x \vert c , {t}_{i} ) - ω {ϵ}_{θ} ( x , {t}_{i} ) \qquad ( 6 )$$

It exactly computes ϵ(x|c, tᵢ, ω), the denoising neural network of p(x|c, ω), at time tᵢ=0. However, it is not a good approximation for tᵢ>0 as it deviates from the FP equation (4) when ω is large, leading to unstable data generation, such as overly saturated and un-natural images. Though techniques like dynamic thresholding can handle color issues by clipping out-of-range pixel values, a systematic solution for general sampling tasks, including latent space diffusion and those beyond image generation, remains absent.

Characteristic guidance is a systematic solution to the large guidance scale issue by correcting the non-linearity neglected in classifier-free guidance. It is a kind of non-linear corrected classifier-free guidance:

$${ϵ}_{C H} ( x \vert c , {t}_{i} , ω ) = ( 1 + ω ) {ϵ}_{θ} ( {x}_{1} \vert c , {t}_{i} ) - ω {ϵ}_{θ} ( {x}_{2} , {t}_{i} ) \qquad ( 7 )$$

in which x₁=x+ωΔx, x₂=x+(1+ω)Δx, and Δx is a non-linear correction term. It is evident that when Δx=0, the characteristic guidance is equivalent to the classifier-free guidance (6).

The correction Δx is determined from the training-free non-linear relation

$$Δ x = P ∘ ( {ϵ}_{θ} ( {x}_{2} , {t}_{i} ) - {ϵ}_{θ} ( {x}_{1} \vert c , {t}_{i} ) ) {σ}_{𝒾} \qquad ( 8 )$$

where σᵢ=\sqrt{1−αᵢ} is a scale parameter and the operator P is the projection module works as an orthogonal projection operator. Equation (8) can be solved using the fixed-point iteration method.

The projection module P acts channel-wisely and is specified by a vector g:

$${P}_{g} ∘ ν = \frac{g \cdot v}{g \cdot g} g \qquad ( 9 )$$

For pixel space diffusion model, characteristic guidance uses the operator g=1 as projection to the channel-wise mean. For latent space diffusion model, characteristic guidance uses g=Δx−(ϵ_{θ}(x, tᵢ)−ϵ_{θ}(x|c, tᵢ)) σᵢ. For low dimensional cases that are not images, characteristic guidance uses the operator P to be identity.

However, existing characteristic guidance approaches are still subject to some stability issues.

### SUMMARY OF THE INVENTION

It is an objective of the present invention to provide an improved characteristic guidance for data generation by diffusion model with enhanced stability over original characteristic guidance approaches.

In accordance with a first aspect of the present invention, an artificial intelligence-based characteristic guidance method is provided for enhancing quality of a diffusion model in generating a new data from a noisy data based on a condition information. The method comprises:
a) initializing an iteration count k to zero and initializing a preceding nonlinear correction vector to a zero vector;
b) setting a guidance scale for control strength of the condition information;
c) generating a nonlinear precorrection vector based at least in part on the noisy data, the condition information, a standard deviation of noise in the noisy data, the guidance scale and the preceding nonlinear correction vector; and
d) performing, by a regularization module, a context regularization iteration to obtain an updated nonlinear correction vector and a nonlinear correction gradient based at least in part on the noisy data, the condition information, the standard deviation of noise, the guidance scale, the nonlinear precorrection vector, and a target regularization value.

In accordance with a second aspect of the present invention, an artificial intelligence-based characteristic guidance system is provided for enhancing quality of a diffusion model in generating a new data from a noisy data based on a condition information. The system comprises: a server; and one or more client devices connected to the server through a network. The server and the one or more client devices are configured to share computation resources with one another in a distributive manner to perform the artificial intelligence-based method according to the first aspect of the present invention.

By using the regularization module, the provided characteristic guidance method not only greatly improves the stability of data generation by the diffusion model, but also provides enhanced control over context through two context modes: the detail enhancement mode and the context enhancement mode. The present invention can enhance the semantic characteristics of prompts and mitigate irregularities in image generation.

### BRIEF DESCRIPTION OF THE DRAWINGS

Embodiments of the invention are described in more details hereinafter with reference to the drawings, in which:

FIG. 1 illustrates a process flowchart for an artificial intelligence-based method for enhancing quality of a diffusion model in accordance with one embodiment of the present invention;

FIG. 2 illustrates a process flowchart for the step of generating a nonlinear precorrection vector in the method of FIG. 1;

FIG. 3 illustrates a process flowchart for the step of performing a context regularization iteration in the method of FIG. 1;

FIG. 4 illustrates a flowchart for the step of denoising noisy data in the method of FIG. 1;

FIG. 5 illustrates a block diagram for a characteristic guidance system configured for performing the characteristic guidance method of FIG. 1;

FIGS. 6A and 6B show respectively a text-to-image generation task and an image-to-image generation task achieved by the characteristic guidance system in accordance with the present invention;

FIG. 7 shows images generated by the characteristic guidance system of the present invention under the two context control modes in comparison with a classifier-free guidance method;

FIGS. 8A and 8B illustrate convergence behaviors of the characteristic guidance system provided by the present invention (operated under the detail enhancement mode), and a conventional characteristic guidance system, respectively.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

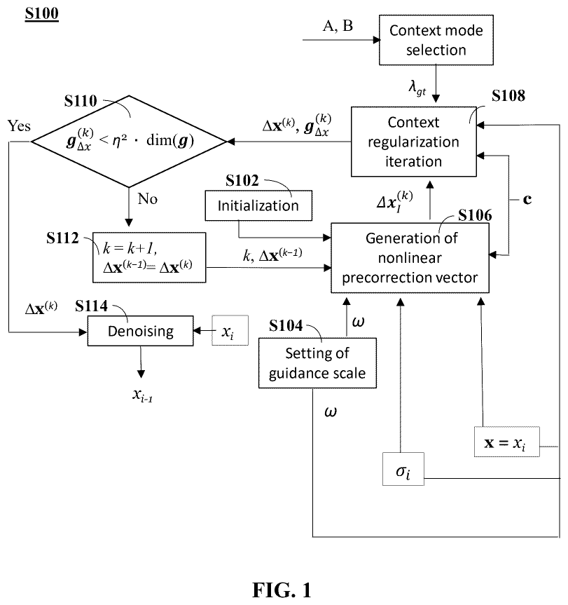

FIG. 1 illustrates a flowchart for an artificial intelligence-based method S100 for enhancing quality of a diffusion model in generating, based on a condition information c, a new data xᵢ₋₁ from a noisy data xᵢ (also denoted as x in the following description) at a diffusion time tᵢ in accordance with one embodiment of the present invention. As shown, the method S100 comprises the following steps:
S102: initializing an iteration count k to zero and initializing a preceding nonlinear correction vector Δx^{(k-1)} to a zero vector;
S104: setting a guidance scale co for control strength of the condition information c;
S106: generating a nonlinear precorrection vector Δxₗ^{(k)} based at least in part on the noisy data x, the condition information c, a standard deviation of noise σᵢ in the noisy data xᵢ, the guidance scale ω and the preceding nonlinear correction vector;
S108: performing, by a regularization module, a context regularization iteration to obtain an updated nonlinear correction vector Δx^{(k)} and a nonlinear correction gradient g_{Δx}^{(k)} based at least in part on the noisy data x, the condition information c, the standard deviation of noise σᵢ, the guidance scale co, the nonlinear precorrection vector Δxₗ^{(k)}, and a target regularization value λ_{gt};
S110: checking if a convergence criterion is met;
S112: if the convergence criterion is not met, incrementing the iteration count (i.e., k=k+l), setting the updated nonlinear correction vector as the preceding nonlinear correction vector (i.e., Δx^{(k-l)}=Δx^{(k)}) and repeating steps S106 to S110;
S114: if the convergence criterion is met, denoising the noisy data x based on the updated nonlinear correction vector to generate the new data xᵢ₋₁.

In step S108, the target regularization value λ_{gt} is correlated with a diffusion time of the diffusion model at each step of the context regularization iteration, and has a highest value when the diffusion time is equal to a total diffusion time of the diffusion model. For example, the target regularization value λ_{gt} may be obtained by:

$${λ}_{gt} = A exp ( \frac{{t}_{i} - {t}_{n}}{B} )$$

where A represents the amplitude of regularization, B represents the effective range of regularization, tᵢ represents the current diffusion time of the diffusion model at step i, and tₙ represents the diffusion time at the final step n (i.e., the total diffusion time) of the diffusion model.

In some embodiments, the target regularization value λ_{gt} is subject to a detail enhancement mode wherein A is in a range from 85 to 100 and B is in a range from 0.6 to 0.9.

In some embodiments, the target regularization value λ_{gt} is subject to a context enhancement mode wherein A is in a range from 1 to 5 and B is in a range from 1 to 5.

In step S110, the convergence criterion may be set as:

$${g}_{Δ x}^{( k )} < {η}^{2} \cdot dim ( g )$$

where η represents a tolerance threshold for convergence serving as a measure to judge if the nonlinearity in the data (e.g. image/audio/signal) have been consistently corrected.

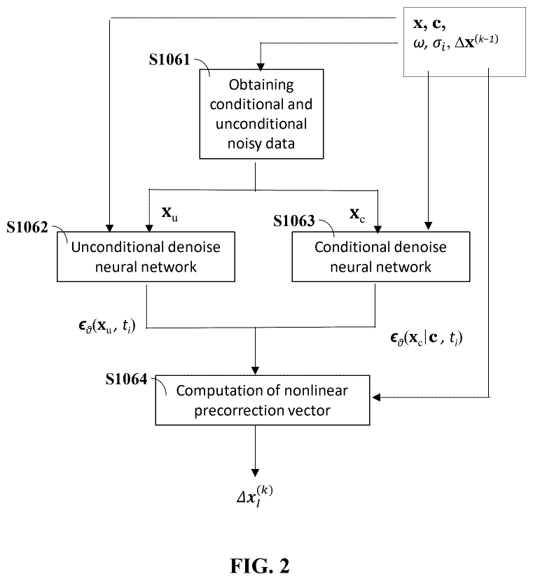

FIG. 2 illustrates a process flowchart for step S106 of generating a nonlinear precorrection vector in accordance with one embodiment of the present invention. As shown, step S106 may comprise:
S1061: defining a conditionally noised data x_{c} and an unconditionally noised data xᵤ based at least in part on the noisy data x, preceding nonlinear correction vector and the guidance scale ω;
S1062: extracting, through an unconditional denoise neural network, an unconditional noise ϵ_{ϑ}(xᵤ, tᵢ) based at least in part on the unconditionally noised data xᵤ; and
S1063: extracting, through a conditional denoise neural network, a conditional noise ϵ_{ϑ}(x_{c}|c, tᵢ) based at least in part on the conditionally noised data x_{c} and the condition information c;
S1064: computing the nonlinear precorrection vector Δxₗ^{(k)} based at least in part on the standard deviation of noise σᵢ, the conditional noise ϵ_{θ}(x_{c}|c, tᵢ) and the unconditional noise ϵ_{ϑ}(xᵤ, tᵢ).

In step S1061, the conditionally noised data x_{c} may be defined as x_{c}=x+ωΔx; and the unconditionally noised data xᵤ may be defined as xᵤ=x+(1+ω)Δx.

For steps S1062 and S1063, the unconditional denoise neural network and the conditional denoise neural network may be obtained by training a denoise neural network ϵ(x, t) respectively by a unconditional diffusion model and a conditional diffusion model, which generates new data based on the given condition c, to predict and remove noise from the noisy data xᵢ under an objective of minimizing a denoising loss function. In some embodiments, the denoising loss function may be defined as Eq. (2), that is,

$$L ( {ϵ}_{θ} ) = \frac{1}{n} {\sum }_{i = 1}^{n} {E}_{{x}_{0} ∼ p ( x ) , {\overline{ϵ}}_{i} ∼ 𝒩 ( 0 , I )} {‖ {\overline{ϵ}}_{i} - {ϵ}_{θ} ( {x}_{{i}^{′}} {t}_{i} ) ‖}_{2}^{2} .$$

In step S1064, the nonlinear precorrection vector Δxₗ^{(k)} may be computed by:

$$Δ {x}_{I}^{( k )} = ( {ϵ}_{θ} ( {x}_{u} , {t}_{i} ) - {ϵ}_{θ} ( {x}_{c} \vert c , {t}_{i} ) ) {σ}_{i} \qquad ( 10 )$$

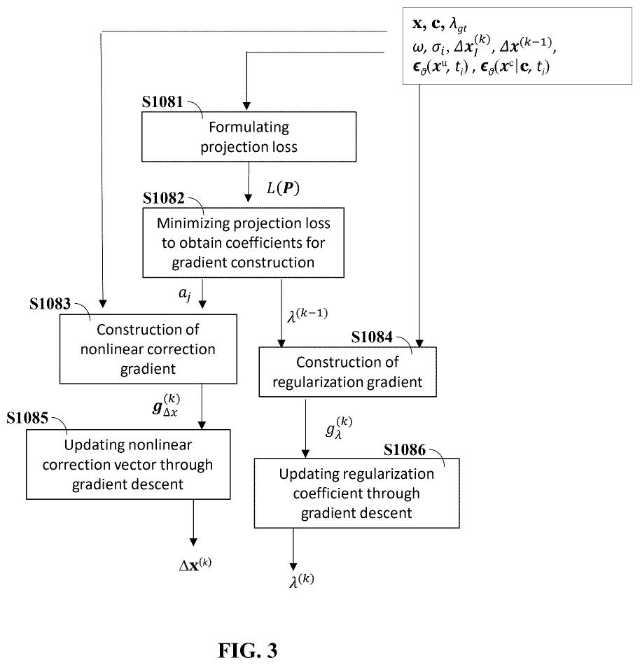

FIG. 3 illustrates a process flowchart for step S108 of performing the context regularization iteration in accordance with one embodiment of the present invention. As shown, step S108 may comprise:
S1081: formulating a projection loss L(P) based at least in part on the nonlinear precorrection vector Δxₗ^{(k)}, a first and a second nonlinear correction coefficients αⱼ, and a regularization coefficient λ^{(k-1)}, and a first and a second normalized nonlinear correction bases \hat{B}_{J}, j=1,2;
S1082: minimizing the projection loss L(P) to obtain the first and second nonlinear correction coefficients αⱼ, and the regularization coefficient λ^{(k-1)};
S1083: constructing the nonlinear correction gradient g_{Δx}^{(k)} based at least in part on the first and second normalized nonlinear correction bases \hat{B}_{J}, the first and second nonlinear correction coefficients αⱼ, and the preceding nonlinear correction vector Δx^{(k-1)};
S1084: constructing a regularization gradient g_{λ}^{(k)} based at least in part on the regularization coefficient λ^{(k-1)} and the target regularization value λ_{gt};
S1085: updating the preceding nonlinear correction vector Δx^{(k-1)} to obtain the updated nonlinear correction vector Δx^{(k)} through gradient descent with the nonlinear correction gradient g_{Δx}^{(k)}; and
S1086: updating the regularization coefficient λ^{(k-1)} to obtain an updated regularization coefficient λ^{(k)} through gradient descent with the regularization gradient g_{λ}^{(k)}.

In step S1081, the projection loss may be formulated as:

$$L ( P ) = {‖ {\sum }_{j = 1 , 2} {a}_{j} {\hat{B}}_{j} - Δ {x}_{I}^{( k )} ‖}_{2}^{2} + {λ}^{( k - 1 )} {\sum }_{j = 1 , 2} {a}_{j}^{2} , \qquad ( 11 )$$

the first normalized nonlinear correction base [symbol] is obtained by: constructing a first nonlinear correction base B₁ by: B₁=(ϵ_{θ}(x, tᵢ)−ϵ_{θ}(x|c, tᵢ)) σᵢ; and normalizing the first nonlinear correction base B₁ by:

$$= \frac{{B}_{1}}{{‖ {B}_{1} ‖}_{2}} ;$$

and
the second normalized nonlinear correction base [symbol] is obtained by: constructing a second nonlinear correction base B₂ by: B₂=ϵ_{θ}(x|C, tᵢ)+ϵ_{θ}(x, tᵢ); and normalizing the second nonlinear correction base B₂ by:

$$= \frac{{B}_{2}}{{‖ {B}_{2} ‖}_{2}} .$$

In step S1083, the nonlinear correction gradient g_{Δx}^{(k)} is constructed by:

$${g}_{Δ x}^{( k )} = Δ {x}^{( k - 1 )} - {\sum }_{j = 1 , 2} {a}_{j} {\hat{B}}_{j} . \qquad ( 12 )$$

In step S1084, the regularization gradient g_{λ}^{(k)} is constructed by:

$${g}_{λ}^{( k )} = ( {λ}^{( k - 1 )} - {λ}_{gt} ) . \qquad ( 13 )$$

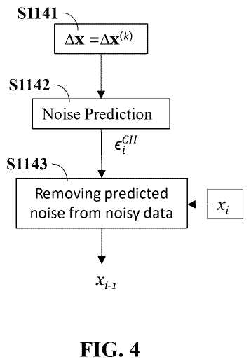

FIG. 4 illustrates a flowchart for step S114 of denoising the noisy data xᵢ based on the updated nonlinear correction vector to generate the new data xᵢ₋₁. As shown, step S114 may comprise:
S1141: returning the updated nonlinear correction vector Δx^{(k)} as an optimized change vector Δx, that is, Δx=Δx^{(k)};
S1142: predicting a noise ϵᵢ^{CH} under characteristic guidance based at least in part on the optimized change vector Δx, the unconditionally noised data xᵤ and the conditionally noised data x_{c}; and
S1143: removing the predicted noise from the noisy data xᵢ to generate the new data xᵢ₋₁.

In step S1142, the noise ϵᵢ^{CH} may be predicted by:

$${ϵ}_{CH} ( x \vert c , {t}_{i} , ω ) = ( 1 + ω ) {ϵ}_{θ} ( {x}_{c} \vert c , {t}_{i} ) - ω {ϵ}_{θ} ( {x}_{u} , {t}_{i} ) . \qquad ( 14 )$$

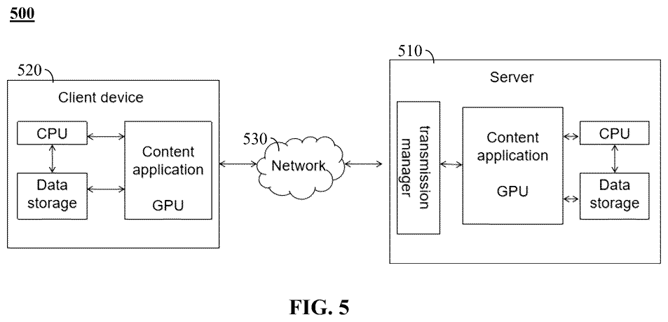

FIG. 5 illustrates a block diagram for a characteristic guidance system 500 configured for performing the characteristic guidance method of S100. The system 500 may include a server 510; and one or more client devices 520 connected to the server 510 through a network 530.

The server 510 and each client device 520 may be equipped with a CPU, data storage, and a GPU. Additionally, the server 510 may include a specialized transmission manager comprising a dedicated network routing system.

In one embodiment, the generation of images or audio is facilitated by a content application implemented on either the client device, the server system, or both. This application adopts the DDPM model, wherein the traditional denoise module is substituted with a characteristic guidance denoise module featuring context regularization iteration. The DDPM model's components—denoising module, steps, and parameters—are stored on the system's data storage and accessed by the device's CPU and GPU. The DDPM process can be distributed between the client device and the server system based on their computational capabilities, typically with the denoising module implemented in the server and the denoising steps stored in the client device.

The process starts when a generation command is activated on a client device. The content application initiates a DDPM process, generating noised image/audio signals and the necessary DDPM parameters. The DDPM process then proceeds to denoise these signals step by step. At each generation step, the noised signal is sent through network to the server system's transmission manager, which forwards it to the server's content application for further denoising. The processed signal is then sent back to the client device through the transmission manager. The final, denoised output is stored on the client device, completing the generation process.

This streamlined approach demonstrates the system's ability to leverage distributed computing resources for efficient image or audio generation, highlighting its potential in applications requiring high-quality media production with sophisticated context-aware enhancements.

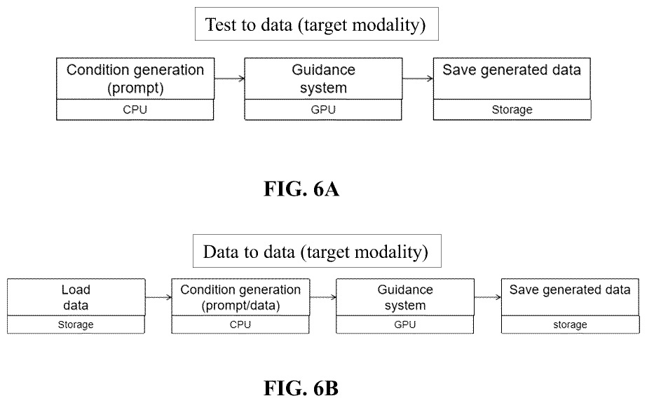

In a text-to-image generation task, the characteristic guidance system can produce high-quality images that boast enhanced details and richer context from text-based prompts. As depicted in FIG. 6A, the process begins when the user inputs a prompt directly or generates one through a natural language processing (NLP) model. Following this, the characteristic guidance system takes the prompt as a conditional input to start the image generation process. Subsequently, the generated image is saved in a specific format and securely stored within the system's storage. This streamlined workflow ensures that users can easily convert textual descriptions into vivid, contextually rich visual representations with minimal effort.

In the image-to-image generation task, the characteristic guidance system facilitates the transformation of initial images into refined versions with enhanced details and context. As depicted in FIG. 6B, the process initiates with the loading of an image from the system's storage. This image is then analyzed by an NLP-based model, which converts it into a descriptive text prompt that encapsulates the essence and context of the original image. Both the original image and its corresponding text prompt are then fed as conditional inputs into the characteristic guidance system. Mirroring the text-to-image task, the system leverages this dual-input to generate a new image that retains the core attributes of the original while infusing it with additional clarity and contextual depth. The final image is saved in a specified format and stored securely within the system's storage.

In an audio generation task, the characteristic guidance system could be used to generate clear and contextually appropriate audio. Text-to-Audio Generation transforms textual prompts into clear, contextually relevant audio. Similar to image generation task, users input text, then the characteristic guidance system take input as condition to generate audio that captures the prompt's essence, suitable for applications ranging from audiobook creation to dialogue generation.

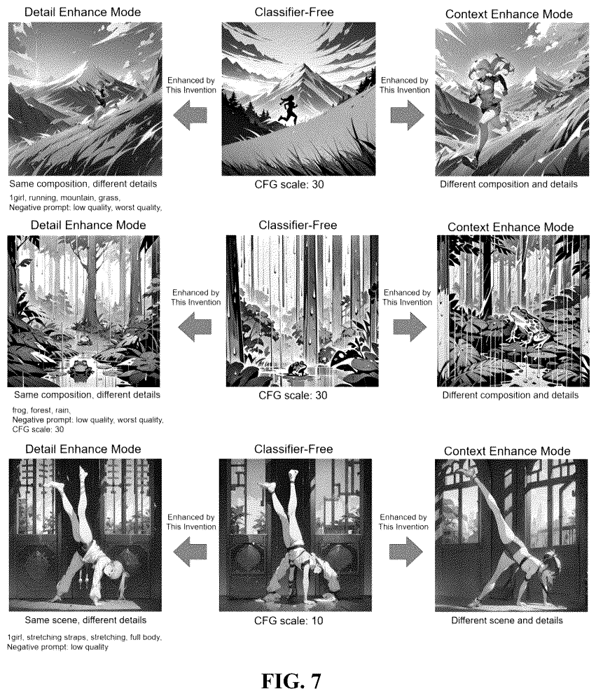

FIG. 7 shows images generated by the characteristic guidance method of the present invention under the two context control modes, the detail enhancement mode and the context enhancement mode, in comparison with a classifier-free guidance method. As shown, both modes have the ability of enhancing the semantic characteristics of prompts and mitigates irregularities in image generation. They also allow the user to control context changes more accurately.

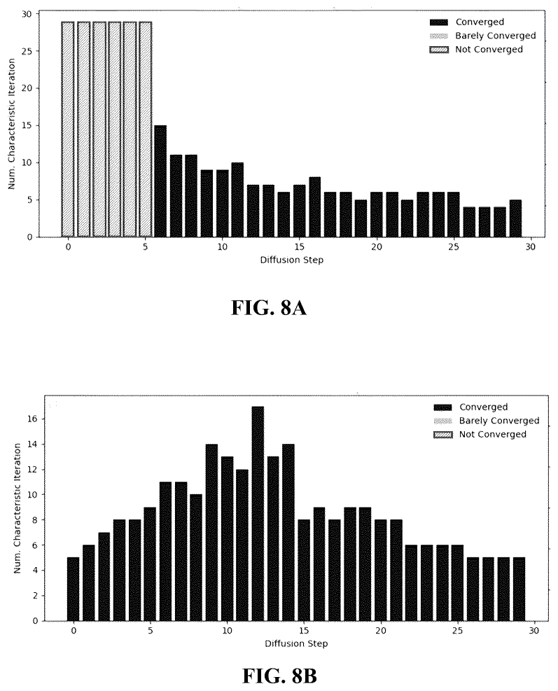

FIGS. 8A and 8B illustrate convergence behaviors of the original characteristic guidance system and the characteristic guidance system of the present invention (under the detail enhancement mode). As shown, the present invention succeeded in ensuring the convergence of every iteration step while the original characteristic guidance fail to converge at the first few steps.

The functional units and modules of the artificial intelligence-based quality-enhancement system in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. An artificial intelligence-based characteristic guidance method for enhancing quality of a diffusion model in generating a new data from a noisy data based on condition information, comprising:
a) initializing an iteration count k to zero and initializing a preceding nonlinear correction vector to a zero vector;
b) setting a guidance scale for control strength of the condition information;
c) generating a nonlinear precorrection vector based at least in part on the noisy data, the condition information, a standard deviation of noise in the noisy data, the guidance scale and the preceding nonlinear correction vector; and
d) performing, by a regularization module, a context regularization iteration to obtain an updated nonlinear correction vector and a nonlinear correction gradient based at least in part on the noisy data, the condition information, the standard deviation of noise, the guidance scale, the nonlinear precorrection vector, and a target regularization value.

2. The artificial intelligence-based characteristic guidance method according to claim 1, further comprising:
e) checking if a convergence criterion is met;
f) if the convergence criterion is not met, incrementing the iteration count, setting the updated nonlinear correction vector as the preceding nonlinear correction vector and repeating steps c) to e); and
g) if the convergence criterion is met, denoising the noisy data based on the updated nonlinear correction vector to generate the new data.

3. The artificial intelligence-based characteristic guidance method according to claim 2, wherein the target regularization value is correlated with a diffusion time of the diffusion model at each step of the context regularization iteration, and has a highest value when the diffusion time is equal to a total diffusion time of the diffusion model.

4. The artificial intelligence-based characteristic guidance method according to claim 3, wherein the target regularization value is obtained by:
$${λ}_{gt} = A exp ( \frac{{t}_{i} - {t}_{n}}{B} )$$
where λ_{gt} represents the target regularization value, A represents the amplitude of regularization, B represents the effective range of regularization, tᵢ represents the current diffusion time of the diffusion model, and t_{T} represents total diffusion time of the diffusion model.

5. The artificial intelligence-based characteristic guidance method according to claim 1, wherein the nonlinear precorrection vector is generated by:
defining one or more noised data from the noisy data based at least in part on the preceding nonlinear correction vector and the guidance scale;
extracting, through one or more denoise neural networks, one or more noises respectively based at least in part on the one or more noised data and the condition information; and
computing the nonlinear precorrection vector based at least in part on the standard deviation of noise, the one or more noises.

6. The artificial intelligence-based characteristic guidance method according to claim 1, wherein the context regularization iteration is performed to obtain the updated nonlinear correction vector and the nonlinear correction gradient by:
formulating a projection loss based at least in part on the nonlinear precorrection vector and one or more normalized nonlinear correction bases to allow the target regularization value to control the amplitude of the nonlinear correction vector;
minimizing the projection loss to obtain one or more nonlinear correction coefficients and a regularization coefficient;
constructing a nonlinear correction gradient based at least in part on the one more normalized nonlinear correction bases, the one or more nonlinear correction coefficients, and the preceding nonlinear correction vector;
constructing a regularization gradient based at least in part on the regularization coefficient and the target regularization value;
updating the preceding nonlinear correction vector to obtain the updated nonlinear correction vector through gradient descent with the nonlinear correction gradient; and
updating the regularization coefficient to obtain an updated regularization coefficient through gradient descent with the regularization gradient.

7. The artificial intelligence-based characteristic guidance method according to claim 1, wherein:
each of the one or more normalized nonlinear correction base is obtained by:
constructing a corresponding nonlinear correction base based at least in part on a corresponding noise and the standard deviation of the corresponding noise;
normalizing the corresponding nonlinear correction base to obtain the normalized nonlinear correction base.

8. The artificial intelligence-based characteristic guidance method according to claim 1, wherein denoising the noisy data based on the updated nonlinear correction vector to generate the data includes:
returning the updated nonlinear correction vector as an optimized change vector;
predicting a noise based on the optimized change vector under characteristic guidance; and
removing the predicted noise from the noisy data to generate the new data.

9. The artificial intelligence-based characteristic guidance method according to claim 1, wherein the noisy data is a noisy image, the condition information is a descriptive text prompt input by a user, and the new data is a new image generated from the noisy image.

10. The artificial intelligence-based characteristic guidance method according to claim 1, wherein the noisy data is a noisy image, the condition information is a descriptive text prompt input extracted from the noisy image, and the new data is a new image generated from the noisy image.

11. An artificial intelligence-based characteristic guidance system for enhancing quality of a diffusion model in generating a new data from a noisy data based on a condition information, comprising:
a server; and
one or more client devices connected to the server through a network;
wherein the server and the one or more client devices are configured to share computation resources with one another in a distributive manner to perform the artificial intelligence-based method of claim 1.

12. The artificial intelligence-based characteristic guidance system according to claim 11, wherein the artificial intelligence-based characteristic guidance method further comprises:
e) checking if a convergence criterion is met;
f) if the convergence criterion is not met, incrementing the iteration count, setting the updated nonlinear correction vector as the preceding nonlinear correction vector and repeating steps c) to e); and
g) if the convergence criterion is met, denoising the noisy data based on the updated nonlinear correction vector to generate the new data.

13. The artificial intelligence-based characteristic guidance system according to claim 12, wherein the target regularization value is correlated with a diffusion time of the diffusion model at each step of the context regularization iteration, and has a highest value when the diffusion time is equal to a total diffusion time of the diffusion model.

14. The artificial intelligence-based characteristic guidance system according to claim 13, wherein the target regularization value is obtained by:
$${λ}_{gt} = A exp ( \frac{{t}_{i} - {t}_{n}}{B} )$$
where λ_{gt} represents the target regularization value, A represents the amplitude of regularization, B represents the effective range of regularization, tᵢ represents the current diffusion time of the diffusion model, and tₙ represents total diffusion time of the diffusion model.

15. The artificial intelligence-based characteristic guidance system according to claim 11, wherein the nonlinear precorrection vector is generated by:
defining one or more noised data from the noisy data based at least in part on the preceding nonlinear correction vector and the guidance scale;
extracting, through one or more denoise neural networks, one or more noises respectively based at least in part on the one or more noised data and the condition information; and
computing the nonlinear precorrection vector based at least in part on the standard deviation of noise, the one or more noises.

16. The artificial intelligence-based characteristic guidance system according to claim 11, wherein the context regularization iteration is performed to obtain the updated nonlinear correction vector and the nonlinear correction gradient by:
formulating a projection loss based at least in part on the nonlinear precorrection vector, one or more normalized nonlinear correction bases to allow the target regularization value to control the amplitude of the nonlinear correction vector;
minimizing the projection loss to obtain one or more nonlinear correction coefficients and a regularization coefficient;
constructing a nonlinear correction gradient based at least in part on the one or more normalized nonlinear correction bases, the one or more nonlinear correction coefficients, and the preceding nonlinear correction vector;
constructing a regularization gradient based at least in part on the regularization coefficient and the target regularization value;
updating the preceding nonlinear correction vector to obtain the updated nonlinear correction vector through gradient descent with the nonlinear correction gradient; and
updating the regularization coefficient to obtain an updated regularization coefficient through gradient descent with the regularization gradient.

17. The artificial intelligence-based characteristic guidance system according to claim 11, wherein:
each of the one or more normalized nonlinear correction base is obtained by:
constructing a corresponding nonlinear correction base based at least in part on a corresponding noise and the standard deviation of the corresponding noise;
normalizing the corresponding nonlinear correction base to obtain the normalized nonlinear correction base.

18. The artificial intelligence-based characteristic guidance system according to claim 11, wherein denoising the noisy data based on the updated nonlinear correction vector to generate the data includes:
returning the updated nonlinear correction vector as an optimized change vector;
predicting a noise based on the optimized change vector under characteristic guidance; and
removing the predicted noise from the noisy data to generate the new data.

19. The artificial intelligence-based characteristic guidance system according to claim 11, wherein the noisy data is a noisy image, the condition information is a descriptive text prompt input by a user, and the new data is a new image generated from the noisy image.

20. The artificial intelligence-based characteristic guidance system according to claim 11, wherein the noisy data is a noisy image, the condition information is a descriptive text prompt input extracted from the noisy image, and the new data is a new image generated from the noisy image.
